(19) United States
(12) Patent Application Publication
(10) Pub. No.: US 2025/0209904 A1
(43) Pub. Date: Jun. 26, 2025

(54) DYNAMIC CONTROL OF DETECTOR SENSITIVITY IN FIRE ALARM CONTROL SYSTEMS

(71) Applicant: Johnson Controls Tyco IP Holdings LLP, Milwaukee, WI (US)

(72) Inventors: Paul Christopher NELSON, Pewaukee, WI (US); Christopher Mark BARRIEAU, Shirley, MA (US); Dennis Allen MCEVOY, Charlotte, NC (US); Richard P. BONNEAU, Templeton, MA (US); Scott Leslie ANDERSON, Milwaukee, WI (US)

(21) Appl. No.: 18/852,210

(22) PCT Filed: Mar. 30, 2023
(86) PCT No.: PCT/US2023/016933

§ 371 Date: Sep. 27, 2024

Related U.S. Application Data
(60) Provisional application No. 63/325,365, filed on Mar. 30, 2022.

(51) Int. Cl. G08B 29/18; G08B 17/00

(52) U.S. Cl. CPC G08B 29/188; G08B 17/00

(57) ABSTRACT

A fire alarm control system includes a plurality of detectors, a control panel, and a control station. Each detector includes a sensor and is configured to generate an alarm signal based on the sensor and an alarm sensitivity. The control panel is configured to receive alarm signals from the plurality of detectors to control alarm devices. The control station is configured to receive an indication of an intended use of a room for a period of time; generate a user interface to receive a configuration of alarm sensitivity for one or more of the plurality of detectors associated with the room; and update the alarm sensitivity for the one or more of the plurality of detectors associated with the room.

### CLAIM OF PRIORITY

The present application claims priority to U.S. Provisional Application No. 63/325,365 filed Mar. 30, 2022, which is assigned to the assignee hereof and incorporated by reference herein.

### FIELD

The present disclosure relates generally to a fire-alarm control systems. More particularly, the present disclosure relates to dynamic control of detector sensitivity in fire-alarm control systems.

### BACKGROUND

Fire alarm systems for large buildings may include multiple detectors such as smoke detectors, heat detectors, carbon-monoxide (CO) detectors, water detectors, etc. The detectors, or a panel associated with the detector, may be configured with a sensitivity for generating an alarm. In some cases, the detector may be configured with a default sensitivity, which is never changed.

Many occupancies, however, experience dynamic change in the use of rooms or other divisions within a building. For example, conference rooms, multi-purpose rooms, gymnasiums, performing arts spaces, etc. may have different uses. The different uses for a space may raise different issues with respect to goals of a fire alarm system. For example, some uses may involve use of artificial fog or other aerosols that can trigger a smoke detector. Alternatively, some uses may involve an increased risk of fire where more sensitivity of the detectors may be desirable. A static configuration of a default sensitivity may result in detection being compromised for some uses or being overly sensitive for other uses. This can lead to either nuisance alarms or inadequate detection

Therefore, there is still a need in the art to improve the functionality and efficiency of sensitivity of detectors in a fire alarm system.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to a fire alarm control system, including: a plurality of detectors, each detector including a sensor and configured to generate an alarm signal based on the sensor and an alarm sensitivity; a control panel configured to receive alarm signals from the plurality of detectors to control alarm devices; and a control station including a memory storing computer-executable instructions, and a processor coupled to the memory and configured to execute the computer-executable instructions to cause the control station to: receive an indication of an intended use of a room for a period of time; generate a user interface to receive a configuration of alarm sensitivity for one or more of the plurality of detectors associated with the room; and update the alarm sensitivity for the one or more of the plurality of detectors associated with the room.

In some aspects, the techniques described herein relate to a fire alarm control system, wherein the processor is configured to execute the computer-executable instructions to suggest the configuration of alarm sensitivity for one or more of the plurality of detectors associated with the room based on an event category of the intended use.

In some aspects, the techniques described herein relate to a fire alarm control system, wherein the processor is configured to execute the computer-executable instructions to verify an access level of a user operating the user interface before updating the alarm sensitivity.

In some aspects, the techniques described herein relate to a fire alarm control system, wherein the plurality of detectors include one or more of: a heat detector, a smoke detector, or a carbon-monoxide detector.

In some aspects, the techniques described herein relate to a fire alarm control system, wherein to receive the indication of an intended use of the room for the period of time, the processor is configured to execute the computer-executable instructions to cause the control station to generate a user interface for receiving event information from a user.

In some aspects, the techniques described herein relate to a fire alarm control system, wherein to receive the indication of an intended use of the room for the period of time, the processor is configured to execute the computer-executable instructions to cause the control station to: receive an indication of the room and the period of time from a business scheduling application; and generate the user interface to receive the configuration of alarm sensitivity in response to the indication from the business scheduling application.

In some aspects, the techniques described herein relate to a fire alarm control system, wherein to receive the indication of an intended use of the room for the period of time, the processor is configured to execute the computer-executable instructions to cause the control station to: receive an indication of the room and the period of time from a heating, vacuuming, and air conditioning (HVAC) application; and generate the user interface to receive the configuration of alarm sensitivity in response to the indication from the HVAC application.

In some aspects, the techniques described herein relate to a fire alarm control system, wherein the processor is configured to execute the computer-executable instructions to cause the control station to revert the alarm sensitivity for the one or more of the plurality of detectors associated with the room to a default mode after the period of time.

In some aspects, the techniques described herein relate to a fire alarm control system, wherein the alarm sensitivity for the one or more of the plurality of detectors associated with the room in the default mode is based on a time of day.

In some aspects, the techniques described herein relate to a fire alarm control system, wherein the processor is configured to execute the computer-executable instructions to cause the control station to revert the alarm sensitivity for the one or more of the plurality of detectors associated with the room to a default mode in response to an indication from a motion detector.

In some aspects, the techniques described herein relate to a method of controlling a fire alarm control system including a plurality of detectors configured to generate an alarm signal based on a sensor and an alarm sensitivity, including: receiving, via a first user interface, an indication of an intended use of a room for a period of time; generating a second user interface to receive a configuration of alarm sensitivity for one or more of the plurality of detectors associated with the room; and updating the alarm sensitivity for the one or more of the plurality of detectors associated with the room.

In some aspects, the techniques described herein relate to a method, further including suggesting, via the second user interface, the configuration of alarm sensitivity for one or more of the plurality of detectors associated with the room based on an event category of the intended use.

In some aspects, the techniques described herein relate to a method, further including verifying an access level of a user operating the second user interface before updating the alarm sensitivity.

In some aspects, the techniques described herein relate to a method, wherein the plurality of detectors include one or more of: a heat detector, a smoke detector, or a carbon-monoxide detector.

In some aspects, the techniques described herein relate to a method, wherein receiving the indication of the intended use of the room for the period of time, includes generating the first user interface for receiving event information from a user.

In some aspects, the techniques described herein relate to a method, wherein receiving the indication of the intended use of the room for the period of time includes receiving an indication of the room and the period of time from a business scheduling application or a heating, vacuuming, and air conditioning (HVAC) application.

In some aspects, the techniques described herein relate to a method, further including reverting the alarm sensitivity for the one or more of the plurality of detectors associated with the room to a default mode after the period of time.

In some aspects, the techniques described herein relate to a method, wherein the alarm sensitivity for the one or more of the plurality of detectors associated with the room in the default mode is based on a time of day.

In some aspects, the techniques described herein relate to a method, wherein reverting the alarm sensitivity for the one or more of the plurality of detectors associated with the room to the default mode is in response to an indication from a motion detector.

In some aspects, the techniques described herein relate to a non-transitory computer-readable medium storing computer-executable code that when executed by a processor of a control station of a fire alarm system including a plurality of detectors causes the control station to: receive an indication of an intended use of a room for a period of time; generate a user interface to receive a configuration of alarm sensitivity for one or more of the plurality of detectors associated with the room; and update the alarm sensitivity for the one or more of the plurality of detectors associated with the room.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1 is a block diagram illustrating the details of a fire alarm system provided in accordance with aspects of the present disclosure.

FIG. 2 is a diagram of an example of a control panel management system (CPMS) for configuring one or more control systems, according to some implementations, in accordance with aspects of the present disclosure.

FIG. 3 is an example user interface for scheduling an event with dynamic detector sensitivity, in accordance with aspects of the present disclosure.

FIG. 4 is an example user interface for configuring sensitivity of detectors for an event, in accordance with aspects of the present disclosure.

FIG. 5 is a flowchart of an example method of operating a fire alarm system, in accordance with aspects of the present disclosure.

FIG. 6 is a block diagram of various hardware components and other features of an example fire panel which is controlled by software instructions to provide several features in accordance with aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The ability of detectors and/or fire alarm control panels (FACPs) to dynamically adjust a sensitivity of a detector provides a capability to adjust the sensitivity of the detectors to specific uses of a room. Control of multiple detectors for specific uses, however, raises a technical problems of how to configure multiple devices. For example, a system may include numerous detectors that could potentially be adjusted. Further, uses of a room where dynamic adjustment of sensitivity is desirable may be limited to a particular period of time. Additionally, adjustments to the sensitivity of the detectors may present risks of the fire detection system being incorrectly configured.

In an aspect, the present disclosure provides for dynamic configuration of the sensitivity of detectors for an event associated with a room for a period of time. The fire alarm system includes a control station that presents an authorized user with an interface to schedule an event for a period of time and set detector sensitivity for the period of time. The scheduling may be initiated manually, or triggered by an external system such as a business scheduling application or a heating, vacuuming, and air conditioning (HVAC) system.

Particular implementations of the subject matter described in this disclosure can be implemented to realize one or more of the following potential advantages. A scheduling interface may automatically identify and control multiple detectors associated with a location of an event to improve an interface for setting sensitivity of the detectors. The dynamic configuration may reduce likelihood of a false alarm due to an event without compromising detection outside of the time period of the vent. Accordingly, the accuracy of alarms for a fire alarm system may be improved.

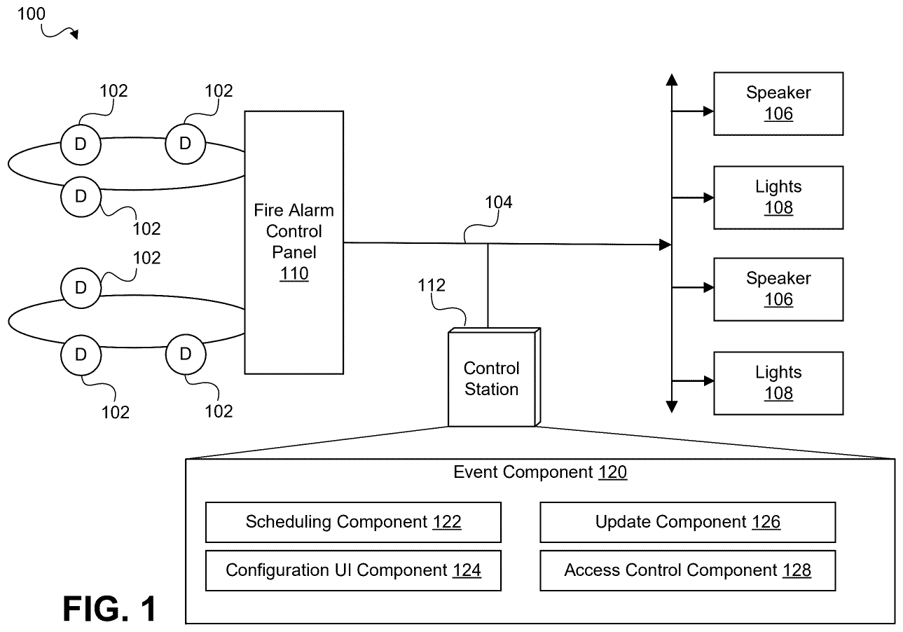

FIG. 1 is a block diagram illustrating the details of a fire alarm system 100 provided according to an aspect of the present disclosure. The fire alarm system 100 includes a fire alarm control panel (FACP) 110, detectors (and/or initiation devices) 102, and notification appliances such as speakers 106 and lights 108 communicatively coupled via a communications network 104. Further, a control station 112 may be coupled to the communications network 104 and may configure any of the detectors 102, FACP 110, speakers 106 or lights 108.

Though not illustrated in FIG. 1, broadly, detectors 102 (e.g., smoke detector, heat detector, carbon-monoxide detector, gas detector, water detector) may be placed in different locations where it is desirable to detect a hazardous event. Speakers 106 may be placed in locations where it would be desirable to play a voice warning message and/or instructions and/or alarms sounds (e.g., horn). Lights 108 may be located in locations to attract attention and/or provide guidance to exits. Control modules and audio transponders may be placed close to corresponding speakers 106. FACPs 110 may be located at places where the various wires (communication mediums) terminate.

Each detector 102 may be configured to detect a hazardous situation (or any undesirable situation for which the detector is designed) in the surrounding area, and may send an alarm signal if/when such a situation is detected/suspected. In general, each detector 102 may have a unique identifier based on its specific location, and the hazardous situation may be determined at the FACP 110 based on the type of detector 102 that sent the alarm signal. The detectors 102 may be connected to a corresponding FACP 110 by a loop structure (using protocols such as ARCnet, or any other similar protocol). In an aspect, each detector 102 may be configured with a sensitivity for generating an alarm signal. Generally, each detector includes a sensor that generates a signal indicating a detected parameter. For example, a heat detector may detect a temperature, a smoke detector may detect a percentage of smoke, a CO detector may detect a level of CO, etc. The sensitivity of the detector may be a threshold at which the detector generates an alarm signal and/or the FACP 110 receiving the detected parameter generates an alarm signal. A detector 102 may output to the communication network 104 a measurement signal indicating the detected parameter and/or an alarm signal indicating an alarm condition.

FACP 110 may receive signals from detectors 102, and may provide a suitable interface for an operator to view the corresponding information. In some implementations, the FACP 110 may receive a measured parameter signal from a detector 102 and compare the measured parameter to a configured sensitivity to determine whether to generate an alarm signal. In some implementations, the FACP 110 may receive an alarm signal generated by a detector 102. The FACP 110 may trigger an alarm based on the alarm signal. For example, the FACP 110 may control speakers 106 in response to the alarm signal.

Speakers 106 are connected to network 104, and may be individually addressable according to the network protocol used on the network. In an aspect, each speaker 106 may be addressable using a corresponding IP (Internet Protocol) address. Each speaker 106 may receive a voice message (“live message”) to be played using VoIP (“Voice over Internet Protocol”), and may play the corresponding message. Each speaker 106 may further receive control messages, which may indicate operations such as increasing the volume, playing a pre-stored message, etc. Alternatively, or in addition, each speaker 106 may receive one or more other alarm messages and correspondingly may generate alarm sounds (e.g., horns, beeps). In some cases, an alarm message may include a voice message, or vice versa.

Control station 112 may provide an interface between the fire alarm system 100 and a user. The control station 112 may allow one or more users to configure the fire alarm system 100 and monitor the fire alarm system 100 during operation. For example, the control station 112 may receive status messages from each of the detectors, FACPs 110, speakers 106, and lights 108. The control station 112 may allow a user to view the status of a specific device or generate a report including the status for multiple devices.

In an aspect, the control station 112 includes an event component 120 configured to dynamically configure detector sensitivity for events during a time period. The event component 120 includes a scheduling component configured to receive an indication of an intended use of a room for a period of time. The event component 120 includes a configuration UI component configured to generate a user interface to receive a configuration of alarm sensitivity for one or more of the plurality of detectors associated with the room. The event component 120 includes an update component 126 configured to update the alarm sensitivity for the one or more of the plurality of detectors associated with the room. In some implementations, the event component 120 may optionally include an access control component 128 configured to verify an access level of a user operating the user interface before updating the alarm sensitivity.

In an aspect, there may be multiple users of the control station 112. Each user may have a set of credentials and an access level. For example, some users such as a security guard may only monitor the fire alarm system 100 via the control station 112. Other users such as building managers will have higher levels of access that allow performing certain tasks. In an aspect, dynamic configuration of detector sensitivity for events may require a relatively high access level such that only users with technical knowledge of the fire alarm system 100 are permitted to change the detector sensitivity.

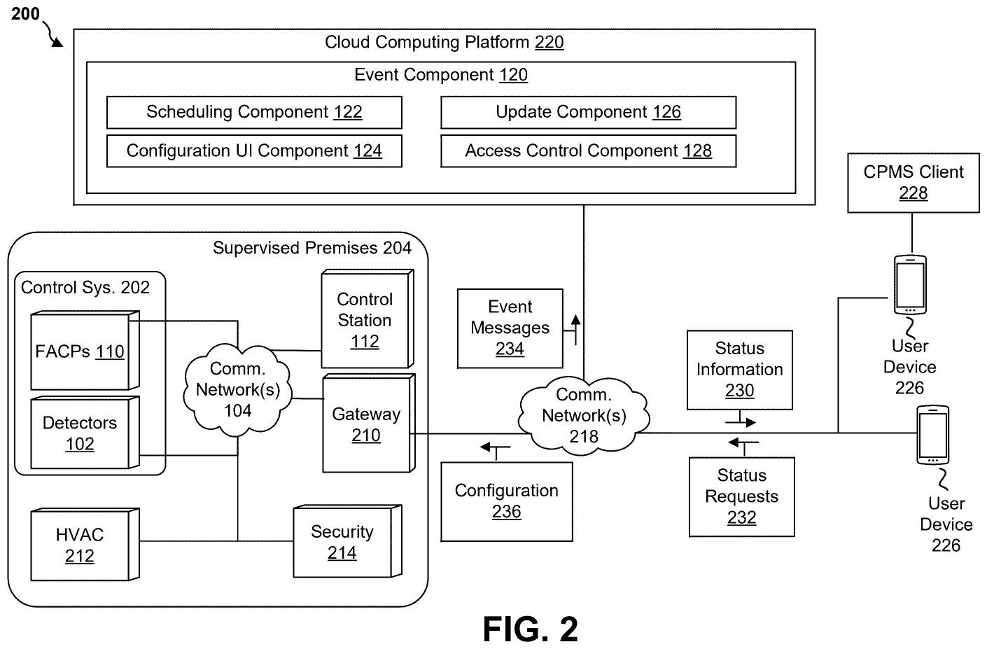

FIG. 2 is a diagram of an example of a control panel management system (CPMS) 200 for configuring one or more control systems, according to some implementations. As illustrated in FIG. 2, a CPMS 200 may include a control system 202 deployed within a supervised premises 204. Further, the control system 202 may correspond to a fire alarm system 100 and include one or more FACPs 110, one or more detectors 102 deployed within the supervised premises 204, one or more local communication networks 104, and a gateway 210. As another example, the control system 202 may include or communicate with a heating, vacuuming, and air conditioning (HVAC) system 212 or a security system 214 via the local communication network 104. In some implementations, the communication network 104 may include a plain old telephone system (POTS), a radio network, a cellular network, an electrical power line communication system, one or more of a wired and/or wireless private network, personal area network, local area network, wide area network, and/or the Internet. Further, in some aspects, the FACPs 110, detectors 102 and gateway 210 may be configured to communicate via the communication networks 104.

In addition, the CPMS 200 may include a cloud computing platform 220, one or more user devices 226, and one or more communication networks 218. The communication network(s) 218 may comprise any one or combination of multiple different types of networks, such as cellular networks, wireless networks, local area networks (LANs), wide area networks (WANs), personal area networks (PANs), the Internet, or any other type of network configured to communicate information between computing devices (e.g., the cloud computing platform 220, the user devices 226, and the gateway 210). Some examples of the user device 226 include smartphones and computing devices, Internet of Things (IoT) devices, video game systems, robots, process automation equipment, sensors, control devices, vehicles, transportation equipment, virtual and augmented reality (VR and AR) devices, industrial machines, etc. The user devices 226 may execute a CPMS client 228 that acts a virtual control station. That is, the CPMS client 228 may replicate features of the control station 112 for remote access at a user device 226.

Further, the cloud computing platform 220 may be configured to provide status information 230 for the FACPs 110 and/or detectors 102 to the CPMS clients 228 of the user devices 226 via the communication network 218 and cloud computing platform 220. In some aspects, CPMS client 228 may be a mobile application, desktop application, or a web application. Further, in some aspects, the CPMS client 228 may send a status request 232, and the cloud computing platform 220 may be configured to transmit the status information 230 in response to a status request 232. In some other aspects, the cloud computing platform 220 may provide the status information 230 to the CPMS client 228 in response to the CPMS client 228 subscribing to the FACPs 110 via the cloud computing platform 220.

As illustrated in FIG. 2, the cloud computing platform 220 may include the event component 120. The event component 120 executing on the cloud computing platform 220 may support the CPMS client 228 to provide the virtualized control station that may be accessed by a user device 226 inside or outside of the supervised premises 204. Further, the cloud computing platform 220 may allow a user with the correct access level to remotely schedule events with dynamic detector sensitivity, as described herein. For example, the control station 112 or other computing devices at the supervised premises 204 (e.g., HVAC system 212 or security system 214) may transmit event messages 234 indicating events that may occur in a room for a period of time. The event component 120 on the cloud computing platform 220 may generate and transmit a configuration 236 for the detectors 102 for dynamic configuration during the event.

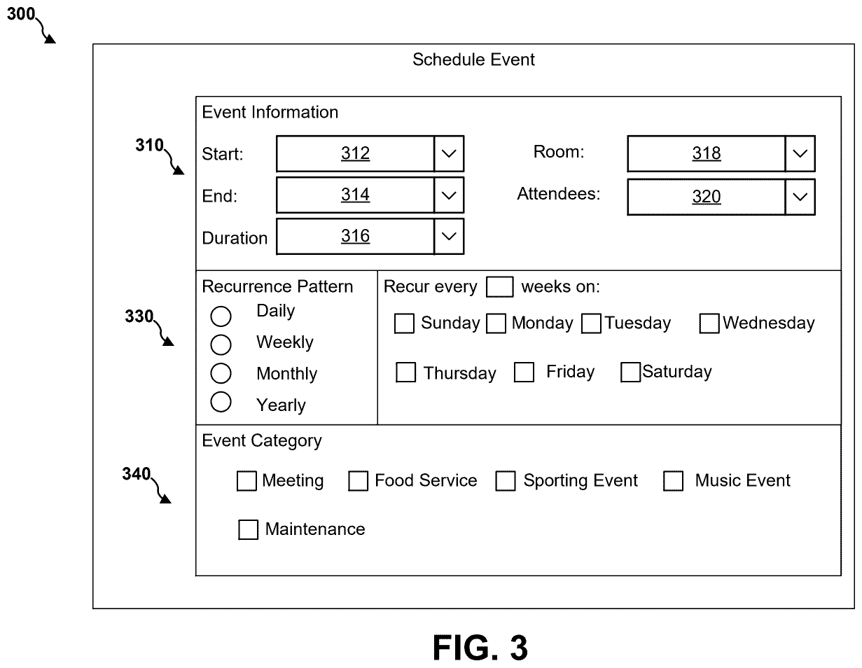

FIG. 3 is an example user interface 300 for scheduling an event with dynamic detector sensitivity. The user interface 300 may be generated by the configuration UI component 124 and displayed on the control station 112 and/or a user device 226 executing the CPMS client 228.

The interface 300 includes event information 310 that define timing and location information about the event. For example, the event information 310 may include fields for a start time 312, an end time 314, a duration 316, a room 318, and attendees 320. Each field may be populated via a drop down menu. The drop down menu for the room 318 may include rooms defined within the fire alarm system 100. For example, a selectable room may include multiple rooms and/or neighboring hallways. The attendees 320 may be an approximate number of people expected to attend the event. For example, the drop down menu may include ranges. The interface 300 may also include recurrence information 330. For instance, a user may use a radio button to select a recurrence pattern and checkboxes to select specific days or times.

The interface 300 may also include event categories 340. In an aspect, the event types may include events or activities that may change the desired sensitivity of the detectors. In an aspect, the event types may be associated with event templates that are configurable by a system administrator to customize the event types for a building. For example, a meeting may be a basic event type that reduces the detector sensitivity because the room is expected to be occupied, but the detector sensitivity may remain within a normal range as no specific activity is expected. In contrast, a food service event type may be associated with food preparation or serving that may include heat sources such as warming trays or cooking surfaces. Because such heat sources may have the potential to create a temporary draft of hot air, a food service event type may be associated with a lower sensitivity for a heat detector. In some implementations, a food service event type may be associated with an increased sensitivity for a smoke detector due to a risk of the heat sources starting a fire (e.g., if left unattended). As another example, a maintenance event may involve use of power tools that may generate small amounts of smoke or heat. Accordingly, a maintenance event may be associated with lower sensitivity. As another example, a sporting event or music event may involve special effects such as artificial fog, which may generate a false alarm for a smoke detector. Accordingly, such events may be associated with lower sensitivity for a smoke detector.

In some implementations, the interface 300 may allow a user to manually schedule the event. For example, the user may initiate the interface 300 from a menu on the control station 112 and enter each piece of information to generate an event.

In some implementations, the control station 112 may be integrated with a business scheduling application such as a calendar application that allows users to schedule events and send out invitations. The control station 112 may initiate the interface 300 in response to an indication from the business scheduling application, for example, in response to an invitation. The control station 112 may pre-populate the interface 300 based on information from the business scheduling application. For example, an invitation may indicate the event information 310 and the recurrence information 330. The user of the control station 112 may complete the interface 300 by selecting the event type. Integration with a business scheduling application may allow people who are not users of the control station 112 to request dynamic configuration of detectors 102 for an event and/or allow the user of the control station 112 to monitor events scheduled by others to determine whether to schedule an event with the fire alarm system 100.

In some implementations, the control station 112 may be integrated with a heating, vacuuming, and air conditioning (HVAC) control system. An HVAC control system may include its own scheduling of overrides, for example, when HVAC services are requested for off-hours events. Such HVAC overrides may also indicate that dynamic configuration of the fire alarm system detectors is appropriate. For example, the sensitivity of the detectors 102 may be set higher when a building or room is expected to be unoccupied. If the HVAC override indicates that a room is expected to be occupied, the control station 112 may initiate the interface 300 to schedule an event to dynamically control the sensitivity of detectors 102. The interface 300 may be prepopulated based on an indication from the HVAC system in a similar manner as with an indication from a business scheduling application.

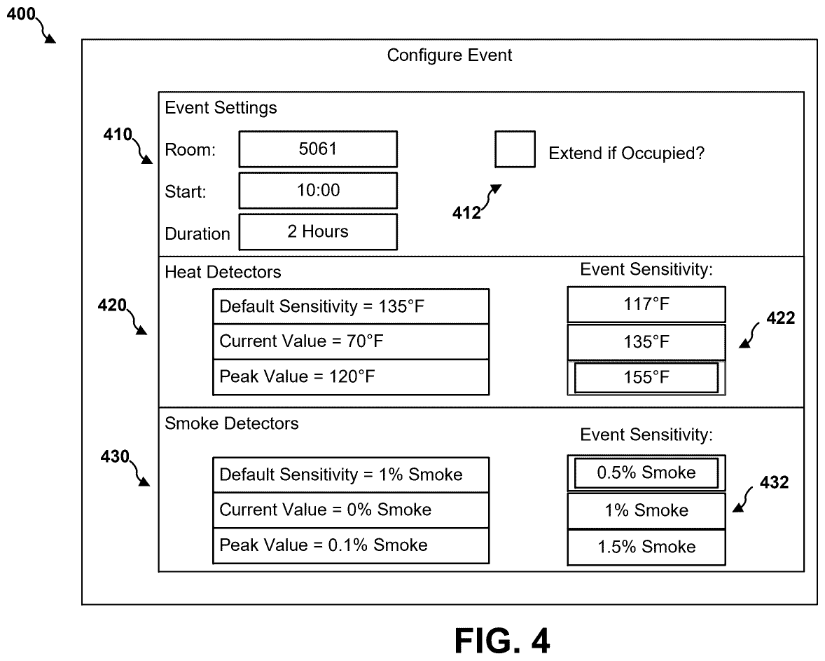

FIG. 4 is an example user interface 400 for configuring sensitivity of detectors 102 for an event. The user interface 400 may be generated by the configuration UI component 124 and displayed on the control station 112 and/or a user device 226 executing the CPMS client 228. For example, the user interface 400 may be generated in response to scheduling an event by the user interface 300. In some implementations, the user interface 400 may be associated with a different access level than the user interface 300. For example, the user interface 400 may require an access level that indicates technical training on the fire alarm system 100 (e.g., a fire marshal or building manager), whereas the user interface 300 may be available to other users of the control station 112. Events scheduled by the user interface 300 may be queued for configuration by the user with higher access level for the user interface 400.

The user interface 400 includes event settings 410 and detector configurations 420 and 430. The event settings 410 may include any of the event information 310 from user interface 300. In some implementations, the event settings may be informative. In other implementations, the user may edit the event settings 410. In some implementations, the event settings 410 include an option 412 to extend the event if the room is occupied. For example, the fire alarm system 100 may include a motion sensor or be integrated with a security system that includes motion sensors. The option 412 may allow the duration of the event to be extended if a motion sensor detects that the room is occupied after the scheduled end of the event. The option 412 may be used, for example, to reduce the chances of a false alarm due to reverting to detector sensitivity for an unoccupied room if an event does not end on time.

The detector configurations 420 and 430 may be grouped by type of detector and may affect any detectors associated with the room for the event. For example, the detector configurations 420 may be for a heat detector. The detector configurations 420 may provide information such as a default sensitivity, current detected value, and peak value. The detector configurations 420 may include buttons 422 for selecting an event sensitivity. In some implementations, the event sensitivity may be limited to pre-defined acceptable values. In some implementations, the user interface 400 may indicate a recommended event sensitivity based on the type of event. For example, for a food service event, the user interface may indicate the highest temperature value (least sensitivity) as the recommended event sensitivity. The information about the default sensitivity, current detected value, and peak value may be helpful for the user to select the event sensitivity. For example, the peak value may indicate the highest detected temperature such that the user may select a sensitivity above the peak value to avoid a false alarm.

As another example, the detector configurations 430 for a smoke detector may similarly include a default sensitivity, current value, peak value and buttons 432 for selecting the event sensitivity. In an implementation, the user interface 400 may recommend the lowest level of smoke (highest sensitivity) for a food service event.

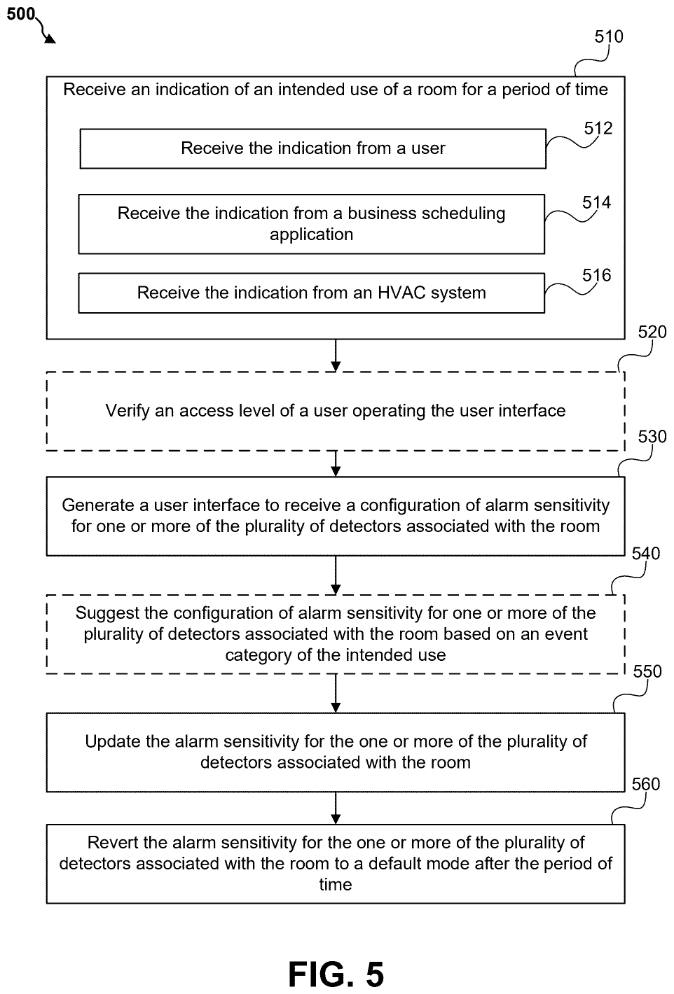

FIG. 5 is a flowchart of an example method 500 of operating a fire alarm system 100. The method 500 may be performed by the control station 112 or the cloud computing platform 220 including the event component 120.

In block 510, the method 500 includes receiving an indication of an intended use of a room for a period of time. For example, the control station 112 or cloud computing platform 220 executing the event component and/or the scheduling component 122 may receive the indication of the intended use of the room for the period of time (e.g., duration 316). For example, in sub-block 512, the scheduling component 122 may receive the indication from a user via the user interface 300. As another example, in sub-block 514, the scheduling component 122 may receive the indication from a business scheduling application. As another example, in sub-block 516, the scheduling component 122 may receive the indication from an HVAC system. The scheduling component 122 may prepopulate the user interface 300 based on the indication from the business scheduling application or the HVAC system.

In block 520, the method 500 may optionally include verifying an access level of a user operating the user interface. For example, the control station 112 or cloud computing platform 220 executing the event component and/or the access control component 128 may verify the access level of the user operating the user interface 400. The access control component 128 may determine whether the access level of the user is sufficient to access the user interface 400 before displaying the user interface 400.

In block 530, the method 500 includes generating a user interface to receive a configuration of alarm sensitivity for one or more of the plurality of detectors associated with the room. For example, the control station 112 or cloud computing platform 220 executing the event component and/or the configuration UI component 124 may generate the user interface 400 to receive a configuration 420, 430 of alarm sensitivity for one or more of the plurality of detectors 102 associated with the room.

In block 540, the method 500 may optionally include suggesting the configuration of alarm sensitivity for one or more of the plurality of detectors associated with the room based on an event category of the intended use. For example, the control station 112 or cloud computing platform 220 executing the event component and/or the configuration UI component 124 may suggest the configuration 420, 430 of alarm sensitivity for one or more of the plurality of detectors 102 associated with the room based on an event category 340 of the intended use. For example, each of the event categories 340 may be associated with a suggested alarm sensitivity for each type of detector. The user interface 400 may suggest the alarm sensitivity by highlighting one of the buttons 422, 432 corresponding to the suggested alarm sensitivity, for example.

In block 550, the method 500 includes updating the alarm sensitivity for the one or more of the plurality of detectors associated with the room. For example, the control station 112 or cloud computing platform 220 executing the event component and/or the update component 126 may update the alarm sensitivity for the one or more of the plurality of detectors 102 associated with the room. For instance, the update component 126 may configure the alarm sensitivity at either the FACP 110 or at the detector 102.

In block 560, the method 500 may optionally include reverting the alarm sensitivity for the one or more of the plurality of detectors associated with the room to a default mode after the period of time. For example, the control station 112 or cloud computing platform 220 executing the event component 120 and/or the update component 126 may revert the alarm sensitivity for the one or more of the plurality of detectors 102 associated with the room to a default mode after the period of time. In some implementations, the default mode may be an alarm sensitivity prior to the dynamic change for the event. In some implementations, the default mode may be based on the time of day, where operating hours are associated with a first set of alarm sensitivities and off-hours are associated with a second set of alarm sensitivities. In some cases, an event may span a change between operating hours and off-hours such that the default mode after the event is not the same as the default mode prior to the event. In some implementations, where the option 412 is selected, reverting the alarm sensitivity for the one or more of the plurality of detectors associated with the room to a default mode may be response to an indication from a motion detector. For example, the motion detector may indicate that no motion has been detected for a second period of time after the end of the event, and the update component 126 may revert the alarm sensitivity to the default mode.

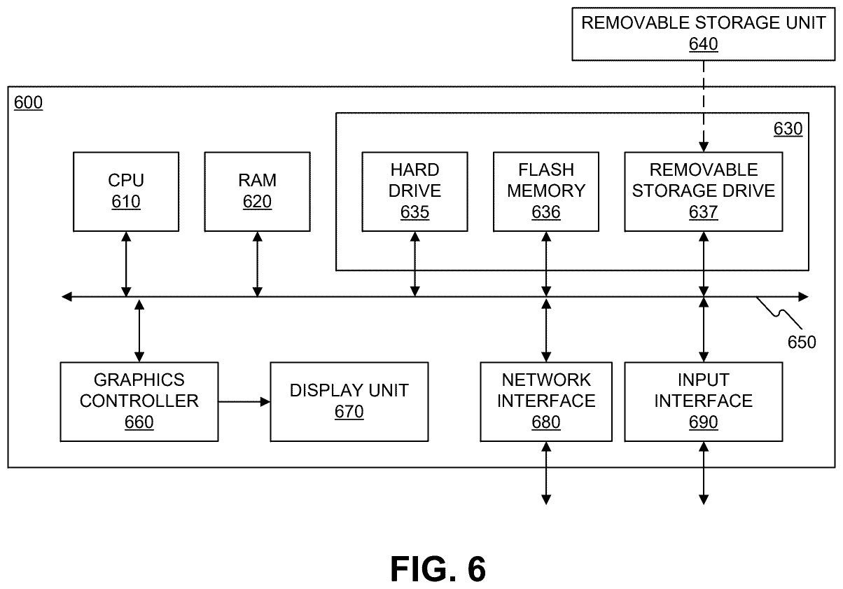

FIG. 6 is a block diagram 600 of various hardware components and other features of an example control station 112 which is controlled by software instructions to provide several features in accordance with aspects of the present disclosure. Control station 112 may include one or more processors such as central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general purpose processing unit.

RAM 620 may receive instructions from secondary memory 630 using communication path 650. The instructions may implement one or more of the various user applications, access module, procedures, etc., described above.

Graphics controller 660 generates display signals (e.g., in RGB format) to display unit 670 based on data/instructions received from CPU 610. Display unit 670 contains a display screen to display the images defined by the display signals. Input interface 690 may correspond to a keyboard and/or mouse. Graphics controller 660, display unit 670, and input interface 690 together provide the user interface 300, 400 described above using which an operator may configure dynamic alarm sensitivity according to various aspects of the present disclosure.

Secondary memory 630 may contain hard drive 635, flash memory 636 and removable storage drive 637. Secondary memory 630 may store the data and software instructions, which enable control station 112 to provide several features in accordance with the present disclosure. Some or all of the data and instructions may be provided on removable storage unit 640, and the data and instructions may be read and provided by removable storage drive 637 to CPU 610. Flash memory, removable memory chip (USB memory drive, microSD card) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable storage medium having stored therein computer software and/or data.

In this document, the term “computer program product” is used to generally refer to removable storage unit 640 or hard disk installed in hard drive 635. These computer program products are means for providing software to control station 112. CPU 610 may retrieve the software instructions, and execute the instructions to cause a control station 112 to provide various features of the present disclosure as described above.

The aspects of the disclosure discussed herein may also be described and implemented in the context of computer-readable storage medium storing computer-executable instructions. Computer-readable storage media includes computer storage media and communication media. For example, microSD card, CompactFlash and USB memory drives. Computer-readable storage media may include volatile and nonvolatile, removable and non-removable media implemented in any method or technology for storage of information such as computer readable instructions, data structures, modules or other data. Non-transitory computer-readable media explicitly excludes transitory signals.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A fire alarm control system, comprising:
a plurality of detectors, each detector comprising a sensor and configured to generate an alarm signal based on the sensor and an alarm sensitivity;
a control panel configured to receive alarm signals from the plurality of detectors to control alarm devices; and
a control station comprising a memory storing computer-executable instructions, and a processor coupled to the memory and configured to execute the computer-executable instructions to cause the control station to:
receive an indication of an intended use of a room for a period of time;
generate a user interface to receive a configuration of alarm sensitivity for one or more of the plurality of detectors associated with the room; and
update the alarm sensitivity for the one or more of the plurality of detectors associated with the room.

2. The fire alarm control system of claim 1, wherein the processor is configured to execute the computer-executable instructions to suggest the configuration of alarm sensitivity for one or more of the plurality of detectors associated with the room based on an event category of the intended use.

3. The fire alarm control system of claim 1, wherein the processor is configured to execute the computer-executable instructions to verify an access level of a user operating the user interface before updating the alarm sensitivity.

4. The fire alarm control system of claim 1, wherein the plurality of detectors include one or more of: a heat detector, a smoke detector, or a carbon-monoxide detector.

5. The fire alarm control system of claim 1, wherein to receive the indication of an intended use of the room for the period of time, the processor is configured to execute the computer-executable instructions to cause the control station to generate a user interface for receiving event information from a user.

6. The fire alarm control system of claim 1, wherein to receive the indication of an intended use of the room for the period of time, the processor is configured to execute the computer-executable instructions to cause the control station to:
receive an indication of the room and the period of time from a business scheduling application; and
generate the user interface to receive the configuration of alarm sensitivity in response to the indication from the business scheduling application.

7. The fire alarm control system of claim 1, wherein to receive the indication of an intended use of the room for the period of time, the processor is configured to execute the computer-executable instructions to cause the control station to:
receive an indication of the room and the period of time from a heating, vacuuming, and air conditioning (HVAC) application; and
generate the user interface to receive the configuration of alarm sensitivity in response to the indication from the HVAC application.

8. The fire alarm control system of claim 1, wherein the processor is configured to execute the computer-executable instructions to cause the control station to revert the alarm sensitivity for the one or more of the plurality of detectors associated with the room to a default mode after the period of time.

9. The fire alarm control system of claim 8, wherein the alarm sensitivity for the one or more of the plurality of detectors associated with the room in the default mode is based on a time of day.

10. The fire alarm control system of claim 1, wherein the processor is configured to execute the computer-executable instructions to cause the control station to revert the alarm sensitivity for the one or more of the plurality of detectors associated with the room to a default mode in response to an indication from a motion detector.

11. A method of controlling a fire alarm control system including a plurality of detectors configured to generate an alarm signal based on a sensor and an alarm sensitivity, comprising:
receiving, via a first user interface, an indication of an intended use of a room for a period of time;
generating a second user interface to receive a configuration of alarm sensitivity for one or more of the plurality of detectors associated with the room; and
updating the alarm sensitivity for the one or more of the plurality of detectors associated with the room.

12. The method of claim 11, further comprising suggesting, via the second user interface, the configuration of alarm sensitivity for one or more of the plurality of detectors associated with the room based on an event category of the intended use.

13. The method of claim 11, further comprising verifying an access level of a user operating the second user interface before updating the alarm sensitivity.

14. The method of claim 11, wherein the plurality of detectors include one or more of: a heat detector, a smoke detector, or a carbon-monoxide detector.

15. The method of claim 11, wherein receiving the indication of the intended use of the room for the period of time, comprises generating the first user interface for receiving event information from a user.

16. The method of claim 11, wherein receiving the indication of the intended use of the room for the period of time comprises receiving an indication of the room and the period of time from a business scheduling application or a heating, vacuuming, and air conditioning (HVAC) application.

17. The method of claim 11, further comprising reverting the alarm sensitivity for the one or more of the plurality of detectors associated with the room to a default mode after the period of time.

18. The method of claim 17, wherein the alarm sensitivity for the one or more of the plurality of detectors associated with the room in the default mode is based on a time of day.

19. The method of claim 17, wherein reverting the alarm sensitivity for the one or more of the plurality of detectors associated with the room to the default mode is in response to an indication from a motion detector.

20. A non-transitory computer-readable medium storing computer-executable instructions that when executed by a processor of a control station of a fire alarm system including a plurality of detectors causes the control station to:
receive an indication of an intended use of a room for a period of time;
generate a user interface to receive a configuration of alarm sensitivity for one or more of the plurality of detectors associated with the room; and
update the alarm sensitivity for the one or more of the plurality of detectors associated with the room.
